(19) United States
(12) Patent Application Publication
(10) Pub. No.: US 2003/0160779 A1
(43) Pub. Date: Aug. 28, 2003

(54) Method and apparatus for managing solid model feature history and changes

(75) Inventors: Boris Rabinovich, Sudbury, MA (US); Phil J. Abercrombie, Belmont, MA (US)

Correspondence Address: LAHIVE & COCKFIELD, 28 STATE STREET, BOSTON, MA, 02109, US

(73) Assignee: Parametric Technology Corporation, Needham, MA

(21) Appl. No.: 10/085,800

(22) Filed: Feb. 26, 2002

(51) Int. Cl. G06T 15/00

(52) U.S. Cl. 345/419

(57) ABSTRACT

A method and apparatus for enabling a user of a computer aided design application to go back to a prior state in the design process of a modeled object without deleting the intermediate steps between that particular prior state and the final or current state. The method includes providing a modeled object in a current state. A rollback function is activated to provide a user with a representation of the modeled object in the prior state without deleting or altering the current state. The modeled object is modified in the prior state to result in a first alternate current state. The current state remains accessible by the user.

### FIELD OF THE INVENTION

The present invention relates to computer aided design applications, and more particularly to the manipulation of modeled objects in a manner enabling a user to revert back to prior versions of a modeled object without deleting existing versions, and follow alternate paths of design.

### BACKGROUND OF THE INVENTION

A computer-aided design (“CAD”) system is a computer implemented tool for engineers and architects to utilize in designing a plethora of structures from products to buildings. The computer portion of the CAD system includes a central processing unit, a display device, such as a computer monitor, and a number of input devices such as, a keyboard, a mouse, a light pen, a digitialising tablet, and the like. The central processing unit has one or more CAD software applications installed thereon.

The CAD software applications allow a user to input and view a design for a particular structure in the form of an object. The user can often rotate the view of the object to any angle, and also zoom in or zoom out for different views and perspectives. Additional visual features such as highlighting, shading, cross-hatching, and the like, enable the user to design an object with the aid of the computing power inherent in the central processing unit. The CAD application can also keep track of, and monitor, design changes to the object in addition to design dependencies. This means that when the user adds or changes an element within the object, other values that depend on that change are automatically updated in accordance with engineering concepts and rules of design.

CAD systems have been in existence for a number of decades. As a result, different CAD systems have been developed utilizing different computer hardware platforms and different computer software applications.

CAD systems can build models of objects based on a feature system. A feature can take the form of a shape, a line, a hole, and the like. One of ordinary skill in the art will appreciate there can be hundreds of different possible features available in CAD systems. A modeled object is formed with one or more of the features. For example, a modeled object could be formed from a block having six sides, each side being square, and a hole passing through a front side to a back side of the block. In this instance the modeled object is a cube with a hole therethrough. The term feature information as utilized herein relates to information that details each of the features that form a modeled object. In the instant example, the feature information would include dimensions, orientations, and locations of the block feature and the hole feature.

Feature history is a sequence of the different combinations of features utilized in modeling a final modeled object as the modeled object is designed. For example, to make a model of a stop sign, an octagon is required. This could be formed by starting with a square, and chamfering off each of the comers of the square to result in the octagonal shape. The feature history would include the original square, then each consecutive shape as each corner is chamfered off, ending with the octagon.

During the design phase of a modeled object, a number of different iterations and potential designs are often attempted prior to establishing a finished product. The development of a final design therefore starts at an original state, passes through a number of intermediate states, and results in a final or current state. The original and intermediate states are prior states relative to a final or current state. At each state along the way, a user can add a number of different features to the modeled object, or delete all or a portion of a number of features.

There are sometimes instances where a user may choose a particular path of development, adding a specific feature and then building additional features off that specific feature. At some state of the modeled object after a number of intermediate states following the addition of the specific feature, the user may decide that they wish to investigate an alternate path of design that did not include the specific feature, or included a variation thereof. However, because the subsequently added features were built off the specific feature, the specific feature cannot simply be deleted. The user could repeatedly use an “undo” feature, which is known in the art. However the “undo” feature will delete all of the intermediate states of the modeled object to reach the prior state where the feature was added. Although the intermediate states are recoverable through a “redo” function, they become permanently deleted if a change is made at the prior state, such as deleting the specific feature. Once a change is made at the prior state, the deleted intermediate states are unrecoverable.

### SUMMARY OF THE INVENTION

There is a need for a function that enables the user to go back to a prior state in the design process of a modeled object without deleting the intermediate steps between that particular prior state and the final or current state. The present invention is directed toward further solutions to address this need.

In accordance with one example embodiment of the present invention, in an electronic device, a method of reverting a computer-aided design (CAD) modeled object back to a prior state in a design process to enable the creation of alternate design paths is provided. The method includes providing a modeled object in a current state. A rollback function is activated to provide a user with a representation of the modeled object in the prior state without deleting or altering the current state. The modeled object is modified in the prior state to result in a first alternate current state. The current state remains accessible by the user.

In accordance with further embodiments of the present invention, the method further includes activating the rollback function to provide the user with a representation of the modeled object in the prior state without deleting or altering the current state or the first alternate current state. The modeled object is then modified in the prior state to result in a second alternate current state. Modifying includes altering a feature that existed in the modeled object.

In accordance with further aspects of the present invention, the step of providing the modeled object includes providing a representation of the modeled object including feature information and feature history. Alternatively, the step of providing the modeled object includes creating a representation of the modeled object with at least one feature.

In accordance with still further aspects of the present invention, the step of activating the rollback function includes selecting the rollback function with a user input device. In addition, the step of modifying includes activating a redo function to reverse a previous undo function.

In accordance with another embodiment of the present invention, the method further includes inserting a plurality of time state indicator stops between modifications of the modeled object.

In accordance with yet another embodiment of the present invention, the method can further include utilizing a rollforward function to return to a state from which the rollback function was activated.

In accordance with one embodiment of the present invention, in an electronic device, a method of manipulating a computer aided design (CAD) modeled object is provided. The method includes providing a modeled object in a current state. A rollback function is activated to provide a user with a representation of the modeled object in a prior state without deleting or altering the current state. The current state remains accessible and updatable.

In accordance with further aspects of the present invention, the method can further include modifying the modeled object in the prior state to result in an updatable first alternate current state. The step of activating the rollback function to provide the user with a representation of the modeled object in the prior state without deleting or altering the current state or the first alternate current state can also be provided. The method can include modifying the modeled object in the prior state to result in a second alternate current state. Further, an undo function can be activated to revert to a previous state of the modeled object.

### BRIEF DESCRIPTION OF THE DRAWINGS

The aforementioned features and advantages, and other features and aspects of the present invention, will become better understood with regard to the following description and accompanying drawings, wherein:

FIG. 1 is a diagramatic illustration of a conventional CAD system;

FIG. 2 is a diagrammatic illustration of a CAD application, according to one aspect of the present invention;

FIG. 3 is a diagrammatic illustration of the utilization of the rollback function and the creation of multiple design paths, according to one aspect of the present invention; and

FIG. 4 is a flowchart showing a progression of steps in utilizing the rollback function, according to one aspect of the present invention.

### DETAILED DESCRIPTION

An illustrative embodiment of the present invention relates to a method and apparatus providing rollback and rollforward functions in conjunction with modifying functions for reverting back to prior states of a modeled object without deletion of intermediate states and moving between different states of a modeled object. The user can follow a normal design process, adding and modifying features in the course of developing a modeled object. Should the user decide part way through the design process that they want to investigate an alternate path of design development, the user can revert back to a prior state of the modeled object. The user can then delete or alter a feature at that prior state, and follow an alternate path of design development. Should the user decide that they need to re-visit the original path of development, the original path remains accessible, despite the creation of the alternate path. Following similar processes, a plurality of alternate paths can be created and maintained, to result in a coexisting plurality of final designs.

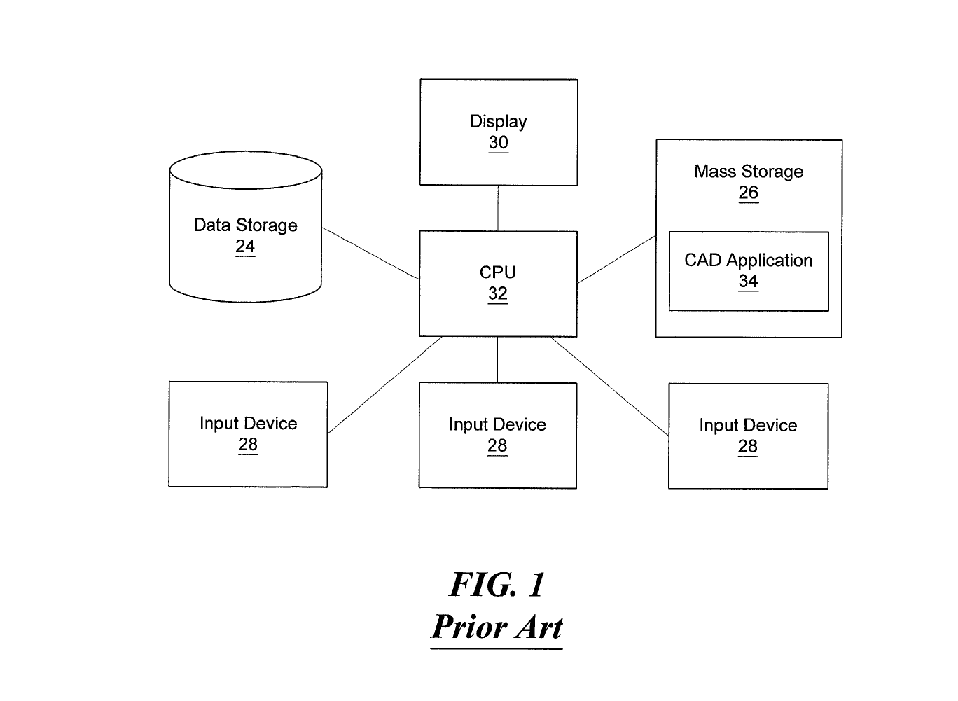

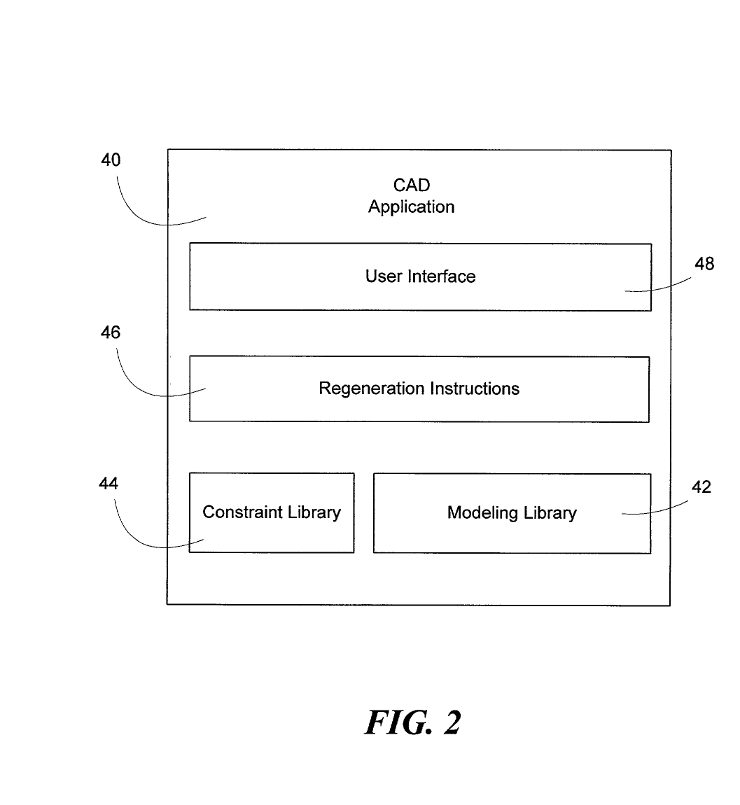

FIG. 1 illustrates a conventional CAD system and conventional CAD application as understood by one of ordinary skill in the art. FIGS. 2 through 4, wherein like parts are designated by like reference numerals throughout, illustrate example embodiments of a method and apparatus for providing a rollback function enabling alternate coexisting paths of design development, according to aspects of the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, type of elements, or materials, form of data, type of application or the like, in a manner still in keeping with the spirit and scope of the present invention.

FIG. 1 illustrates a conventional computer aided design (“CAD”) system 20. The CAD system 20 includes hardware and software components. A computing apparatus 22 forms the hardware portion of the CAD system 20. The computing apparatus 22 is a programmable device that responds to a specific set of instructions in a well defined manner and can execute a set of instructions. The computing apparatus 22 can include a storage device 24, which enables the computing apparatus 22, to store at least temporarily, data, information, and programs (e.g., RAM or ROM). A mass storage device 26 can substantially permanently store data, information, and programs (e.g., a disk drive or tape drive). An input device 28 can be provided through which data and instructions enter the computing apparatus (e.g., a keyboard, mouse, stylus, light pen, or a digitizing tablet). An output device 30 can be provided to display or produce results of computing actions (e.g., display screen, printer, plotter, or infra red, serial, or digital port). A central processing unit (CPU) 32 can include a processor for executing the specific set of instructions.

A CAD application 34 can be installed, or in communication, with the computer apparatus 22 to provide instructions for processing. The CAD application 34 can be used for e.g., engineering, manufacturing, architectural, or other design or manufacturing functions. One of ordinary skill in the art will appreciate that CAD systems in the past have existed in the form of a dedicated hardware device incorporating the CAD functions and unable to perform non-CAD related operations. More recent CAD systems make use of mainframe or personal computer hardware platforms and are embodied in software applications installed thereon.

FIG. 2 shows a diagrammatic illustration of a CAD application 40, which is an example embodiment of a CAD application suitable for use in conjunction with the teachings of the present invention. The CAD application 40 includes a first library 42 of executable routines. The modeling library 42 of executable routines enables the creation and evaluation of CAD geometry. This modeling library 42 can contain the feature history and model deltas of a modeled object. For example, as the design process of a modeled object evolves, the feature history is sequentially established and stored by the modeling library 42.

In addition to the modeling library 42, a constraint library 44 can function in conjunction with the modeling library 42. The constraint library 44 controls the governing dimensions and parameters of the design, driving the placement of assembly components, and interrelating objects. For example, when a project is initiated, and during the design process, on a CAD system, certain project constraints can be provided for the modeled object. These constraints can include dimensional constraints, material constraints, weight constraints, strength constraints, and the like. The constraint library 44 monitors the design process and guides the placement and characteristics of the features as they are added to the modeled object to ensure the final result fits within a predetermined specification.

Regeneration instructions 46 work in conjunction with the constraint library 44 and the modeling library 42. Regeneration instructions 46 utilize the constraint library 44 to specify the location of features and then construct the features in the modeling library 42.

The CAD application 40 is controlled by a user through a user interface 48. The user interface 48 can include a command-line-based or graphical user interface. Alternatively, the user interface can take the form of an abstract programming application program interface (API). If a user wants to create a modeled object with the CAD application 40, the inputs of the user in creating the modeled object are taken by the user interface 48 and forwarded to the other components of the CAD application 40 described herein. More specifically, the user interface 48 takes the user input to build regeneration instructions 46. The regeneration instructions, as previously described, work in conjunction with the constraint library 44 and the modeling library 42 to create the modeled object in the CAD application 40.

The present invention as described below, relates to the modeling of the modeled object and providing the user with the ability to move between different states of a modeled object during the design process and branch through different design paths. Therefore, the modeling library 42 substantially implements the teachings of the present invention in the example CAD application 40 configuration. However, one of ordinary skill in the art will appreciate that the teachings of the present invention are not restricted to the exemplified CAD application, or implementation by the modeling library 42. Rather, the teachings of the present invention can be implemented by an application in any manner allowing the functions of the present invention to operate in an equivalent manner to the description herein.

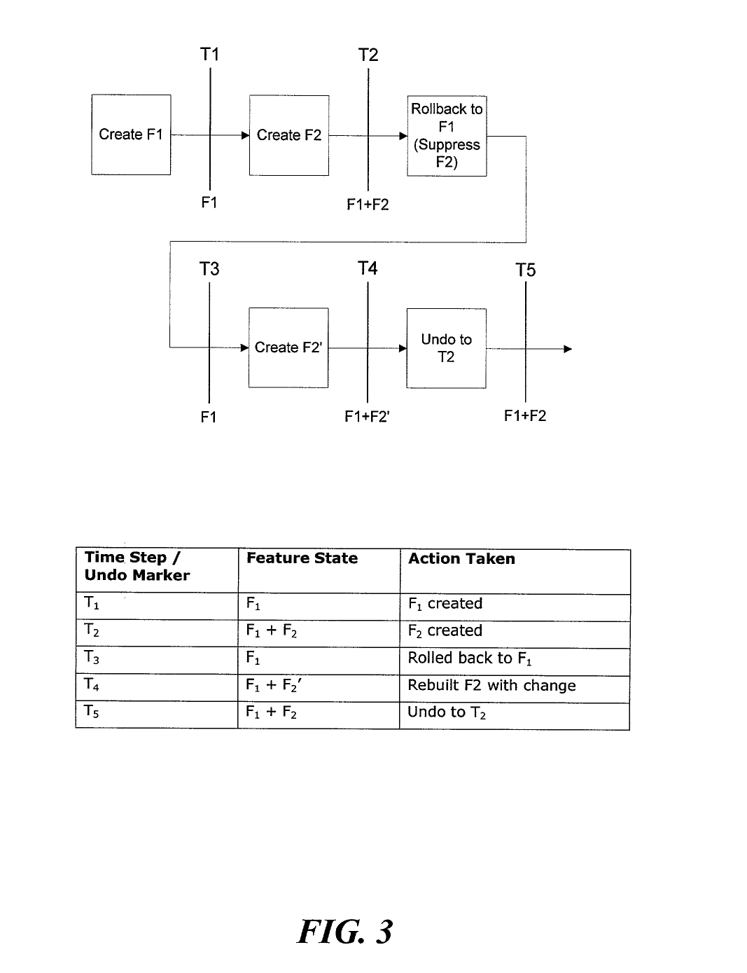

FIG. 3 is a diagrammatic illustration showing the progression of states as a modeled object is formed along a design path with a corresponding table summarizing the state of the design path for each location on the diagram. The illustrated progressions are intended only as representative of one possible design scenario. One of ordinary skill in the art will appreciate that the teachings of the present invention enable a user to follow myriad different paths and combinations in creating a modeled object design. The design path can be characterized as a collection of feature information and feature history that results in a modeled object design.

In the diagram and table of FIG. 3, one example string of feature information and feature history is depicted, which shows how the rollback function and the undo function can work together to allow multiple variations of a model. In this figure, user interactions are represented by boxes, and the resultant state of the system is indicated by vertical lines located after each user interaction along the timeline. The user first creates feature F1 resulting in feature F1 being present at time state T1. Feature F2 is added to feature F1, which results in a model that contains both feature F1 and feature F2 at time state T2. The user then suppresses feature F2 by utilizing the rollback function to roll back to feature F1. This action results in only F1 being present at state T3, because the user has shifted the position in time to when only F1 was present at T1.

At this point in the design process, the user introduces a different version of feature F2 called feature F2′. The feature F2′ can, for instance, have different dimensions or properties than the original feature F2. The addition of feature F2′ results in a model that contains both feature F1 and feature F2′ at time state T4. The addition of F2′ also causes a branch to form in the design process that enables development of alternate path in the design process. However, this alternate path does not permanently delete the original design path. The user can utilize an undo function to return to time state T2, so that at time state T5, the model and design is equivalent to the model at time state T2.

The rollback function can be activated in a number of different ways as will be appreciated by one of ordinary skill in the art. For example, the function can be activated through use of a user input device with a menu system, with one or more keystrokes on a keyboard, or with a combination of clicks on a mouse, or the like.

The rollback function enables the user to move through the feature history of the modeled object from a starting point to prior states of the modeled object. The rollback function also includes a rollforward function, which can be used to return to a point from which the rollback function was executed. For example, in FIG. 3, the user rolled back from a model with features F1 and F2 at time state T2 to a model with only feature F1 at time state T3 (equivalent to time state T1). If the user decides they do not want to leave the model rolled back at time state T3 (equivalent to time state T1), they can execute a rollforward function to return to the model with feature F1 and feature F2 (equivalent to time state T2). Alternatively, the user can utilize the undo function to undo the rollback and revert back to the state with both features F1 and F2 at time state T5 (equivalent to time state T2).

A distinction between the rollback and rollforward functions and the undo function is that rollback and rollforward create forward moving events in the undo timeline. Every rollback and rollforward operation can be undone, allowing every previous feature state to be accessed.

It should be noted that the user maintains the ability to move from the original design path to multiple alternate design paths without losing any of the paths that are interrupted by the creation of the alternate paths. The ability to access the feature information and feature history allows the movement between design paths. Functions, such as “rollback” and “rollforward”, when used in conjunction with undo, among others, can be executed at any time state along the design paths to create new and different design destinations.

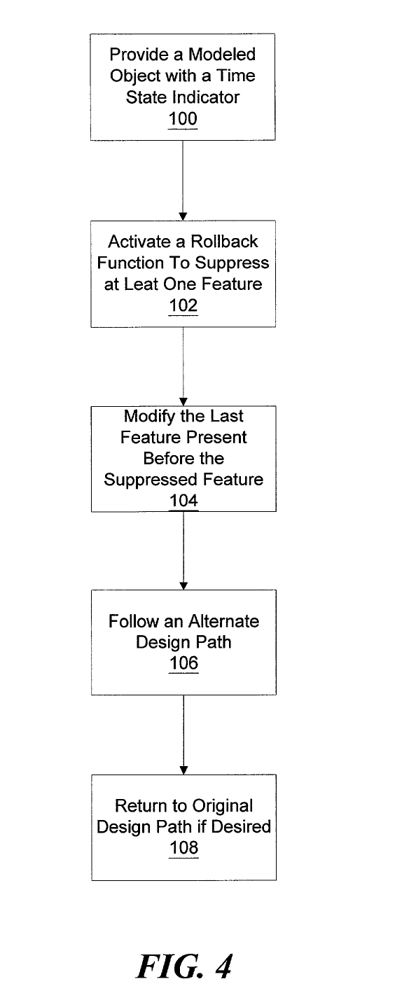

FIG. 4 illustrates a flowchart showing one possible combination of design steps in accordance with one embodiment of the present invention. There must first exist a modeled object in a current state, which the CAD application or the user designates with a time state indicator mark, such as an “undo” mark (step 100). The current state is simply that state at which the modeled object currently exists. If the modeled object is complete, the current state is equivalent to a final state. Prior to the current state, there exists a prior state, which is a state before the current state. The prior state can be the original state of the modeled object, or can be any intermediate state between the first state and the current state throughout the feature history.

A rollback function, in accordance with the teachings of the present invention, is activated to provide the user with a representation of the modeled object in a specified prior state (step 102). The rollback function operates by suppressing features most recently added to a list of features forming the model, and providing the user with the ability to identify one of the time state indicators as the point in the feature history to which the user would like to revert. These time state indicators can be set automatically by the CAD application, or can be set manually by the user as they progress through the design process.

In performing the rollback function, the user is able to scroll back through time state indicators and the prior states of the modeled object with prior features as it had been developed along the feature history. However, the act of scrolling through the time state indicators is not equivalent to a more conventional undo function. The undo function, acting without the rollback function, will take a user back through each time state indicator of the modeled object, but will do so in a manner that precludes making any changes to any intermediate states without deleting all states that had been scrolled through to reach that point. A user can “undo” through time state indicators, and “redo” to replace the undone actions back to the current state. However, without working in conjunction with the rollback feature, this only enables the user to view the prior states, not modify them.

To continue with the present invention, the user can then modify the modeled object (step 104) to result in a first alternate state, along a first alternate path. For example, as illustrated in FIG. 3, the first alternate state is at time state T4. The modification to the modeled object can take the form of a number of different actions. The modification can take the form of a deletion, an addition of a feature, changing characteristics, dimensions, locations, orientations, or other elements of a feature, as one of ordinary skill in the art will appreciate. The modification is most often a dimensional change to a pre-existing feature.

The user can then follow along the alternate design path (step 106) for as many design steps and iterations as desired. If the user determines they need to revisit the original design path, the user may do so by undoing to a time state indicator on the original design path (step 108) and following the path to a predetermined point. In addition, the user can branch either the original path or the first alternate path into a second alternate path, utilizing the above-mentioned steps. Additional alternate paths are also enabled by the method and apparatus of the present invention.

The system and method of the present invention enables a rollback function for reverting back to prior states of a modeled object without deletion of intermediate states. The user can follow a normal design process, adding and modifying features in the course of developing a modeled object. The user can revert back to a prior state of the modeled object in the middle of an existing design path at any time. The user can then delete or alter a feature at that prior state, creating an alternate path of design development, and ultimately an alternate design. The original path, and any alternate paths previously generated, all remain accessible. Therefore, multiple features histories exist if there are multiple design paths. Following similar processes, a plurality of alternate paths can be created and maintained, to result in a coexisting plurality of final designs.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the invention, and exclusive use of all modifications that come within the scope of the appended claims is reserved. It is intended that the present invention be limited only to the extent required by the appended claims and the applicable rules of law.

What is claimed is:

1. In an electronic device, a method of reverting a computer-aided design (CAD) modeled object back to a prior state in a design process to enable the creation of alternate design paths, comprising:
providing a modeled object in a current state;
activating a rollback function to provide a user with a representation of the modeled object in the prior state without deleting or altering the current state; and
modifying the modeled object in the prior state to result in a first alternate current state;
wherein the current state remains accessible by the user.

2. The method of claim 1, further comprising activating the rollback function to provide the user with a representation of the modeled object in the prior state without deleting or altering the current state or the first alternate current state.

3. The method of claim 2, further comprising modifying the modeled object in the prior state to result in a second alternate current state.

4. The method of claim 1, wherein modifying comprises altering a feature that existed in the modeled object.

5. The method of claim 1, wherein providing the modeled object comprises providing a representation of the modeled object including feature information and feature history.

6. The method of claim 1, wherein providing the modeled object comprises creating a representation of the modeled object with at least one feature.

7. The method of claim 1, wherein activating the rollback function comprises selecting the rollback function with a user input device.

8. The method of claim 1, wherein modifying comprises activating a redo function to reverse a previous undo function.

9. The method of claim 1, further comprising inserting a plurality of time state indicator stops between modifications of the modeled object.

10. The method of claim 1, further comprising utilizing a rollforward function to return to a state from which the rollback function was activated.

11. In an electronic device, a method of manipulating a computer aided design (CAD) modeled object, comprising:
providing a modeled object in a current state; and
activating a rollback function to provide a user with a representation of the modeled object in a prior state without deleting or altering the current state;
wherein the current state remains accessible and updatable.

12. The method of claim 11, further comprising modifying the modeled object in the prior state to result in an updatable first alternate current state.

13. The method of claim 11, further comprising activating the rollback function to provide the user with a representation of the modeled object in the prior state without deleting or altering the current state or the first alternate current state.

14. The method of claim 13, further comprising modifying the modeled object in the prior state to result in a second alternate current state.

15. The method of claim 11, further comprising activating an undo function to revert to a previous state of the modeled object.

16. The method of claim 11, wherein providing the modeled object comprises providing a representation of the modeled object including feature information and feature history.

17. The method of claim 11, wherein providing the modeled object comprises creating a representation of the modeled object with at least one feature.

18. The method of claim 11, wherein activating the rollback function comprises selecting the rollback function with a user input device.

19. The method of claim 11, further comprising utilizing a rollforward function to return to a state from which the rollback function was activated.

20. The method of claim 11, wherein modifying comprises activating a redo function to replace a previous undo function.

21. The method of claim 11, further comprising inserting a plurality of time state indicator stops between modifications of the modeled object.

22. A computer readable medium containing software suitable for executing a method of reverting a CAD modeled object back to a prior state in a design process to enable the creation of alternate design paths, the method comprising:
providing a modeled object in a current state;
activating a rollback function to provide a user with a representation of the modeled object in the prior state without deleting or altering the current state; and
modifying the modeled object in the prior state to result in a first alternate current state;
wherein the current state remains accessible by the user.

23. A computer readable medium containing software suitable for executing a method of manipulating a CAD modeled object, comprising:
providing a modeled object in a current state; and
activating a rollback function to provide a user with a representation of the modeled object in a prior state without deleting or altering the current state;
wherein the current state remains accessible and updatable.
